(19) United States
(12) Patent Application Publication
(10) Pub. No.: US 2011/0010533 A1
(43) Pub. Date: Jan. 13, 2011

(54) System and Method for Component Trust Model in Peer-to-Peer Service Composition

(75) Inventors: John Buford, Lawrenceville, NJ (US); Rakesh Kumar, Brooklyn, NY (US); Keith Ross, Brooklyn, NY (US); Gregory M. Perkins, Pennington, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/991,498

(22) PCT Filed: Sep. 12, 2006
(86) PCT No.: PCT/US06/35465

§ 371 Date: Sep. 27, 2010

Related U.S. Application Data
(63) Continuation of application No. 60/718,968, filed on Sep. 20, 2005.

(51) Int. Cl. G06F 21/00; H04L 9/00

(52) U.S. Cl. 713/150; 726/1

(57) ABSTRACT

A system is provided for composition trust binding in a peer-to-peer network environment. The system includes: a service requestor (21) residing on a peer (22) in the network and able to invoke a service (23) residing on another peer (24) in the network. The service requestor is also able to communicate a composition trust binding to the peer hosting the service, where the composition trust binding i a set of rules that define a collection of allowable software components which may be invoked by the service. A validation agent (25) ensures that the service executes in accordance with the binding.

### FIELD

The present disclosure relates to peer-to-peer networking and, more particularly, to a system and method for composition trust binding.

### BACKGROUND

In a pervasive computing environment, a node may offer a service to other nodes. The service may be composed or aggregated from services from other nodes, and any service may be composed of software components provided by different parties. By aggregating service facilities across nodes, a collection of limited-resource devices may be able to offer services that would otherwise not be available. However, nodes which invoke or participate in these services may be concerned about the integrity and trustworthiness of the various components that are combined to provide these services.

Conventional methods for assuring trustworthiness of software components include software audits and digitally signed software binaries; these methods are typically used to convey trustworthiness to the end-user or developer, and there is no explicit representation of trust between components. Further, these methods do not explicitly validate composite services that may be created from different service sources.

The approach presented here allows a node which creates, uses or participates in service delivery to enforce its service composition trust requirements by creating an explicit trust binding between the components that may participate in a service composition. This set of rules is referred to here as a composition trust binding (CTB). A composition trust binding is a set of rules which define the collection of allowable components for a particular service. An exemplary interpretation of a composition trust binding is: these components are permitted to be used in the combinations specified for implementing a service interface or processing specific content.

A service-invoking node can distribute a composition trust binding to the service-providing node which is then expected to enforce the composition trust binding policy as to which components are permissible for use in delivery of the service. Similarly a content-owning node can distribute a composition trust binding to a service which processes the content, which is then expected to enforce the composition trust binding policies during access to that content. Further, a service-providing node can publish a composition trust binding for its composite services to aid nodes during service discovery to find services that satisfy the node's composition trust policy.

Conceptually the composition trust binding extends the practice of digitally signed software, which is used to provide software component trust. The digital signature is a secure and verifiable indicator by the source or third-party validator of the component, and thus is a statement of the integrity of the component. Digitally signed software assures the component to the platform in which the component is installed, to other applications installed on that platform, and to users of applications on that platform. However this assurance is invisible to remote applications which invoke services on the platform which in turn use these components. Similarly, content owners whose content has been transferred to the platform for processing have no way to obtain assurance about the components processing the content by using digitally signed software alone.

The enforcement of a composition trust binding provides additional assurance in networks where nodes in multiple administrative domains share computational resources and may be used to process information which is under an access control policy. This assurance can be given both dynamically and statically, in that the enforcement can be performed at the initial use of a service or periodically during the service use. A composition trust binding validator is an agent that verifies' that a particular execution combination of components, services and/or platform is valid according to the composition trust binding required by the invoking node or application or user of the combination, or according to the composition trust binding required by the content owner or licensor which is processed by the combination. composition trust binding requires a mechanism for enforcement, such that the composition trust binding and the enforcing agent can not be compromised.

The statements in this section merely provide background information related to the present disclosure and may not constitute prior art.

### SUMMARY

A system is provided for composition trust binding in a peer-to-peer network environment. The system includes: a service requestor residing on a peer in the network and able to invoke a service residing on another peer in the network. The service requestor is also able to communicate a composition trust binding to the peer hosting the service, where the composition trust binding is a set of rules that define a collection of allowable software components which may be invoked by the service. A validation agent ensures that the service executes in accordance with the binding.

Further areas of applicability will become apparent from the description provided herein. It should be understood that the description and specific examples are intended for purposes of illustration only and are not intended to limit the scope of the present disclosure.

### DRAWINGS

FIG. 1 illustrates how a service description can be augmented to identify sub-interfaces;

FIG. 2 is a diagram depicting a system for composition trust binding in a peer-to-peer network environment;

FIG. 3 is an exemplary scheme for defining a composition trust binding;

FIG. 4 is a diagram illustrating how a validation agent may integrate into an execution environment of a peer.

FIG. 5 is a diagram illustrating the use of a composition trust binding in a data path;

FIG. 6 is a diagram illustrating the use of a composition trust binding in a control path; and

FIG. 7 is an exemplary architecture for enforcing peer-to-peer negotiation.

The drawings described herein are for illustration purposes only and are not intended to limit the scope of the present disclosure in any way.

### DETAILED DESCRIPTION

Categories of service composition that are important for pervasive computing include: virtual devices, multimodal interfaces, and computational concurrency or load distribution. A device's software and hardware components can be packaged as services and combined in arbitrary ways. Many consumer electronics (CE) devices are specialized for specific uses. Due to form factor and cost considerations, devices vary in capability. With sufficiently high bandwidth network interfaces on these devices, such as 802.11 and UWB, it is practical for sets of networked devices to share functionality.

Combining different devices can extend the user interface of the device and aggregated devices can be composed into new virtual devices. For instance, a video camera networked to a cell phone can use the cell phone's IMP software to send instant messages. In another instance, a video camera networked to a cell phone or car audio receiver can augment the memory of such devices by storing information from either device on its SD card. In yet another instance, a video camera networked to a car flipdown video display and a cell phone can use the former to display its user interface and video playback, and the latter as an input device for keypad input.

Multimodal user interfaces can be created by combining and coordinating user input/output from multiple devices. For example, geographic maps and location awareness from the car navigation system can be combined with streaming video about nearby landmarks to a camera display and speech input from a cellphone.

Decomposition of computation across multiple nodes can be used for concurrency or distributing computational load, as in grid computing. Applications for computation concurrency with personal CE devices include content-based retrieval, semantic search, image analysis, information fusion, and simulation.

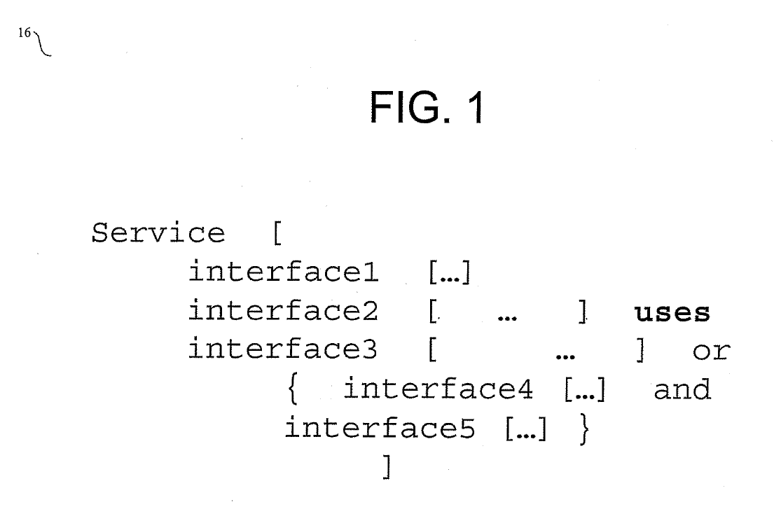

Networked devices can offer hardware and software components as services which can be dynamically discovered using various service discovery protocols. For example, a service might invoke services provided by several other peers as part of performing the indicated service, and/or service composition might be nested. The selection of a component in such distributed computations can be done in a number of different ways, such as using a service discovery protocol, prescription by the invoking node, or configuration. To make the dynamic composition explicit in such scenarios, service descriptions can be augmented to identify sub-interfaces used as shown in FIG. 1. In this example, the service description identifies the two interfaces provided by the service. In addition, the service description has been modified to further identify the sub-interfaces which may be invoked by interface2. Interface2 may invoke interface3, or interface4 and interface5. While service composition enables a number of interesting applications and provides additional flexibility, it creates new vulnerabilities. These are possible because any component in a composition is a potential exposure to backdoors, trojan horses, security holes, and masquerading components.

In general, these threats concern not only the specific node providing the service but also any node or peer invoking the service (i.e., control path) and any node or peer whose data or content are processed by the service (i.e., data path). Consequently, existing techniques for software integrity such as digitally signed software or peer authentication are insufficient because they fail to address component security from the perspective of the service invoker or content provider. A way to securely prescribe the allowed components in these types of compositions is described below.

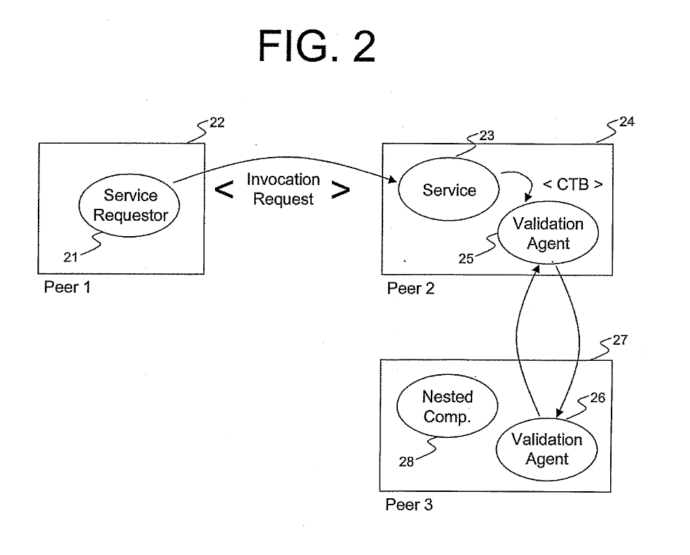

FIG. 2 depicts a system 20 for composition trust binding in a peer-to-peer network environment. A service requestor 21 resides on a first peer 22 or computing node in the network. The service requestor 21 is able to invoke a service 23 residing on another peer 24 in the network. In addition, the service requestor 21 may communicate a composition trust binding to the peer 24 hosting the service as further described below. To securely enforce the binding, it is preferably encrypted, such as by using the peer's public key.

A composition trust binding is a set of rules that define a collection of allowable software components which may be invoked by the service. In an exemplary embodiment, the software components specified in the rule set are permitted to be invoked by the service. In an alternative embodiment, the rule set may specify those software components which are not to be invoked, so that unspecified software components may be invoked by the service.

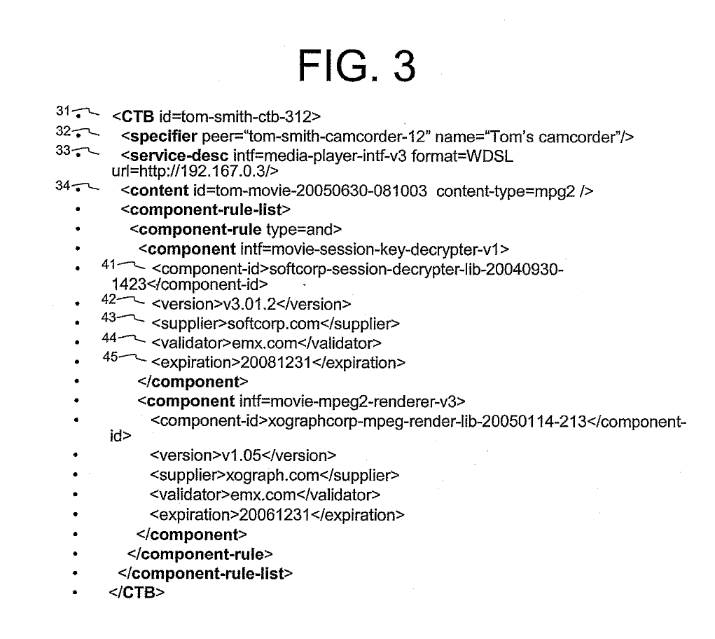

An exemplary scheme for the rule set is provided in FIG. 3. This exemplary scheme includes an identifier 31 for the rule set, an identifier 32 for an owner of the rule set, a description of the service 33 the rule set applies to, and an identifier 34 for content the rule set applies to. In addition, the scheme provides a list of component rules, where each rule is a list of software components that are permitted to be invoked by the service. In this example, a decrypter component and an MPEG rendering component are permitted to be invoked by the media player service. It is envisioned that the rule set may include multiple component rules and each rule may specify different combinations of software components. The combinations of software components may also be formulated using different types of Boolean operators (e.g., component A and (component B or C)). Lastly, a software component may include a software library, an application, a service interface, operating system or platform.

For each specified software component, the rule set may further define an identifier 41 for the software component, a version 42 for the software component, a supplier 43 for the software component, a validator 44 for the software component and/or an expiration date 45 for the component rule. There may be multiple suppliers and/or validators for a given component. Moreover, these attributes may be used to formulate more generic restrictions. For example, the rule may specify a given software component having a version number higher than version 2.1 is acceptable. In another example, the rule set may specify that any type of software component supplied (or validated) by Microsoft is acceptable. These types of rules may be formulated through the use of wildcards. Other types of information, such as decryption keys or license identification, may be provided for a given software component.

Experience in the evolution of various software platforms such as Java, DCOM, and CORBA shows that interfaces change relatively slowly compared to implementations. Nevertheless there is the case that a service offering peer might move to a new version of an interface with a different composition model before the service user or content provider has validated these and produced a new composition trust binding. Further, implementations that had previously been validated might be obsoleted as when the vendor no longer supports them or the vendor no longer exists. A content licensee might be left without the ability to use the content and a service user might face service interruption. These problems are not unique to composition trust binding (such as software that no longer runs on an upgraded OS). A solution for composition trust binding that cannot be updated is a backward compatible deployment of the necessary services, and for composition trust binding that can be updated, a mechanism by which content licensees can obtain updated composition trust binding as needed.

Composition complexity relates to the size of each interface, the number of component interfaces, and the nesting depth of the composition. The service composition is effective if the unit of composition is an interface rather than individual methods, and that interface complexity in existing service-oriented architectures is representative of what to expect in peer-to-peer service composition. If service composition uses interfaces as the unit, then the composition trust binding complexity will always be less than the corresponding service descriptions.

A service may be composed of other services to an arbitrary nesting level. A composition trust binding might prescribe only the first level components, if the validated component services include Composition trust binding that the composite composition trust binding trusts. A composition trust binding might prescribe component compositions to several levels, but this increases the complexity of the composition trust binding and makes it more difficult to maintain. The composition trust binding also becomes sizeable if components are implemented by large numbers of software providers.

Finally, the composition trust binding assumes that content publishers and service users are aware of services from different implementers. Past experience with component suppliers for distributed middleware such as DCOM, CORBA and Java EJB suggests that this is manageable, and online registries could be created to streamline this communication.

With reference to FIG. 2, a validation agent 25 verifies that a particular execution combination of components, services and/or peers is valid according to the trust binding required by the invoking peer or application or user of the combination, or according to the trust binding required by the content owner or licensor which is processed by the combination. For nested compositions, the validation agent 25 will coordinate with downstream validation agents to insure compliance. For instance, the validation agent 25 may communicate with a validation agent 26 on yet another peer 27 to verify a component 28 residing on this peer. Enforcement of constraints on nested components is recursively decomposable. Local agents communicate with each remote agent to enforce the next level of service composition. Thus, local agents trust that remote agents enforce the immediate compositions as well as further nested compositions. Each remote agent repeats the process for its nested composition.

The validation agent is associated with the peer hosting the requested service and may be integrated with a component participating in the application or service, or in the operating system. Different techniques may be employed for securing the validation agent. In one exemplary embodiment, the validation agent resides in a secure operating system on a trusted computing platform. The secure operating system is one or more software programs digitally signed by the providers and/or integrators of the secure operating system. The secure OS is also certified for secure and trusted installation and execution on the platform. The validation agent is a software program digitally signed by the provider of the validation agent and may be additionally signed by a third party verifier. In another embodiment, the validation agent may be secured via a smart card, Java Card, or other security technology. It is understood that other technique for securing the validation agent are within the scope of this disclosure.

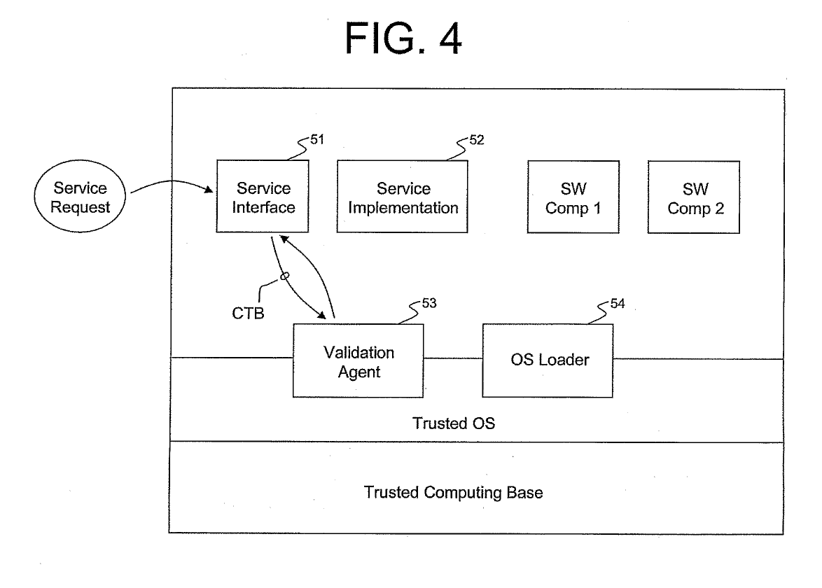

FIG. 4 illustrates how the validation agent may integrate into a secure operating system of a given peer. In operation, a service invocation is directed along with a composition trust binding to an interface 51 for the requested service 52. The composition trust binding is in turn passed along to the validation agent 53. The validation agent 53 checks the software components specified in the binding against the available software components in the execution environment. In an exemplary embodiment, the validation agent 53 is integrated with or interacts with an operating system loader 54 to determine the available components. If the available components satisfy the component rules defined in the binding, then the invocation request is granted by the validation agent 53. On the other hand, if the component rules are not met, then the invocation request fails.

In an alternative approach, software components could register with the validation agent when they are launched in the execution environment. The validation agent would maintain a data store of the available components. When a composition trust binding is received by the validation agent, the binding is checked against the data store.

Each component of a binding must have a secure, unique, verifiable id. The binding must be encrypted, such as by using the peer's public key when the composition trust binding is generated. The composition trust binding is not intended to describe dynamic variations in component use at different points in a process lifetime. The validator may not be able to enforce or monitor all possible communication paths between possible components, and the composition trust binding is not intended to replace access control and authorization mechanisms. The strength of the composition trust binding is to express a known set of component relationships that have been validated through other means (e.g., software audit and integration testing) for a specified environment or platform, so that components adhering to the specified service interfaces and signed by trusted parties are expected to adhere to the desired access policy with greater reliability than component combinations that have not be validated.

A digital signature on the component indicates that the software is from the given supplier. Alternatively if the software is signed by a content issuer, it could indicate that the content issuer authenticates the software as a playback component for its content. Or, if the software is signed by a third party validator, it could be that the software has been audited or validated by the third party. The intent then is to provide assurance to the content issuer and the licensee that the component does not have a backdoor, trojan horse, or other hole that would lead to the encryption keys being exposed. The signature is an indirect statement that the supplier of the component has validated the integrity of the component for its functional purpose, whereas the composition trust binding is a statement that a prescribed set of components from possibly many sources are considered reliable and trustworthy for the indicated service.

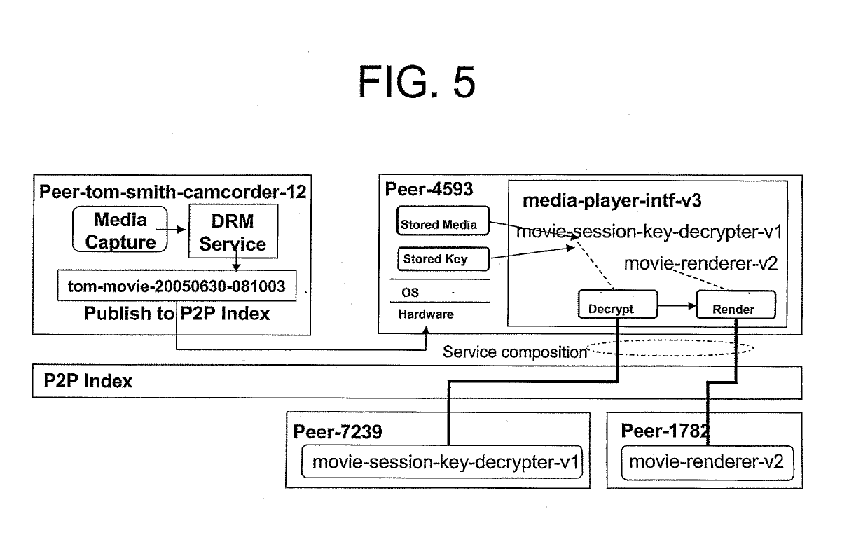

FIG. 5 illustrates personal content publishing in a peer-to-peer environment. In this example, the camcorder used to capture the media also immediately encrypts the media, applies the owner's rights management policy, and prepares it for publication to a wide-area peer-to-peer index. Additionally, the camcorder incorporates a composition trust binding (labeled “tom-smith-composition trust binding-312”) which is either encrypted into the content file or encrypted with the license file for the content.

Once the content is published in the peer-to-peer (P2P) index, any peer may retrieve it using existing methods for keyword search in peer-to-peer file sharing systems. In this example, peer-4593 has retrieved the media file “tom-movie-20050630-081003” from the P2P index. Peer-4593 uses a local service (media-player-intf-v3) which plays the content, assuming the peer also has the appropriate license. In addition, this media player service uses two components which may be either local or provided by other peers. In this simplified example, the components provide two key functions of the media player: media decryption and media rendering. Peer-7239 and Peer-1782 are previously registered services in the P2P index which correspond to these interfaces. Peer-4593 can discover these services and use them to perform the necessary function.

Because the content owner Tom Smith has associated a composition trust binding with the encrypted media file, the binding is used to enforce Tom Smith's policies about which components can be used to implement the media-player service. A validation agent will prevent the media player from invoking either of these two software components unless they have been specified in the composition trust binding. Conversely, the media player may invoke these components when they have been specified in the composition trust binding.

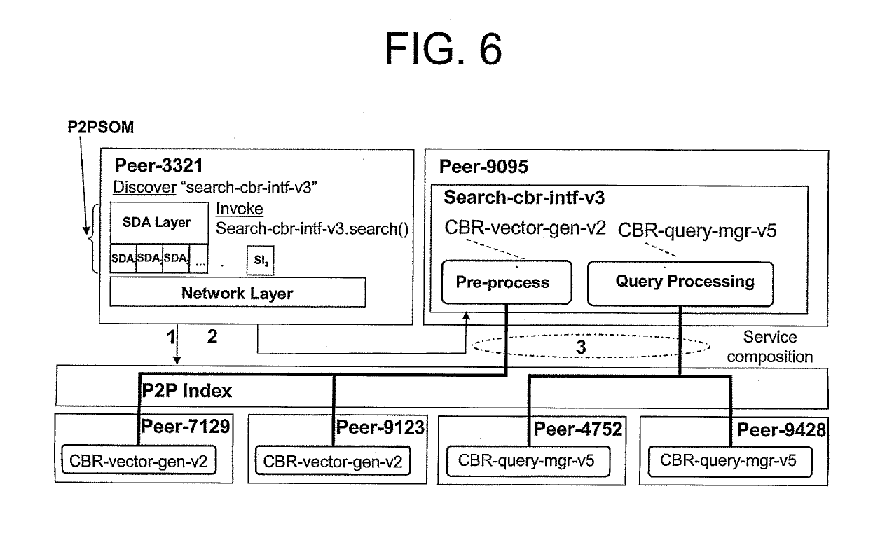

In a similar manner, composition trust bindings may be used in the control path as shown in FIG. 6. In this example, peer-3321 discovers peer-9095 which offers a service for content-based retrieval (CBR). Peer-3321 invokes the retrieval process service on peer-9095 and includes a composition trust binding with the request. The service search-cbr-intf-v3 uses two component services, one for pre-processing the CBR vectors (CBR-vector-gen-v1) and the other for managing queries (CBR-query-mgr-v5). Peer-9095 offloads the computational load of the retrieval process by distributing the vector generation and query processing to other available peers. A validation agent again validates the two component services according to the binding.

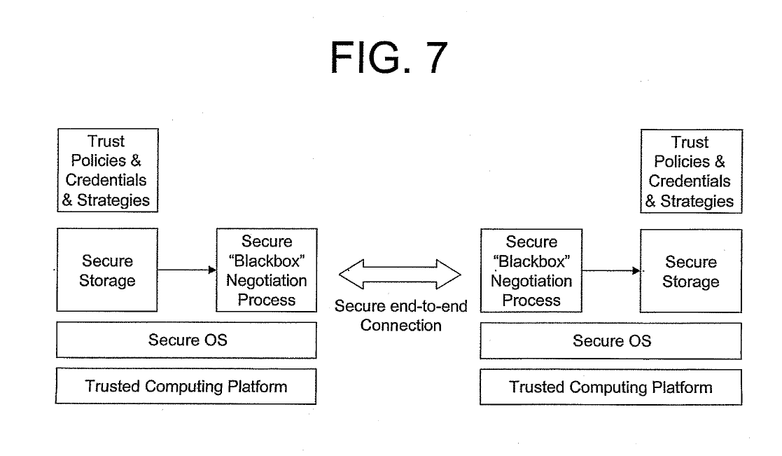

FIG. 7 is an exemplary architecture for enforcing peer-to-peer negotiation, during which peers exchange information about trust credentials, the secure operating system and components participating in the negotiation. Further details regarding this exemplary architecture may be found in the following publications: J. Buford, R. Kumar, G. Perkins; Composition Trust Bindings in Pervasive Computing Service Composition; IEEE Workshop on Pervasive Computing and Communication Security (PerSec) March 2006 and J. Buford, I Park, G. Perkins; Social Certificates and Trust Negotiation; IEEE Consumer Communications and Networking Conference (CCNC 2006) Jan 2006. The system and method for composition trust binding described above may be used in this architecture. It is understood that composition trust binding may also be used in conventional trust negotiation as well as other privacy-enforcing trust negotiation architectures.

The above description is merely exemplary in nature and is not intended to limit the present disclosure, application, or uses.

What is claimed is:

1. A system for composition trust binding in a peer-to-peer network environment, comprising:
a service residing on a peer in the network and operable to execute at least one software component when invoked;
a service requestor residing on another peer in the network, the service requestor operable to invoke the service and to communicate to the peer a set of rules which define allowable software components for the service; and
a validation agent residing on the peer, the validation agent adapted to receive the set of rules from the service requestor and verify that the service executes in accordance with the set of rules.

2. The system of claim 1 wherein the rule set defines combinations of two or more allowable software components which may be invoked by the service.

3. The system of claim 1 wherein the rule set further defines an identifier for the rule set, an identifier for an owner of the rule set, and a description of the service the rule set applies to or an identifier for content the rule set applies to.

4. The system of claim 1 wherein the rule set further defines, for each allowable software component, at least one of an identifier for the software component, a version for the software component, a supplier for the software component, a validator for the software component or an expiration date for the component rule.

5. The system of claim 1 wherein the service requestor is operable to encrypt the rule set prior to communicating the rule set to the peer.

6. The system of claim 1 wherein the service ignores the invocation request from the service requestor when the software components to be executed by the service are not specified in the rule set.

7. The system of claim 1 wherein the service invokes the at least one software component only when the software component is specified in the rule set.

8. The system of claim 1 wherein the validation agent is incorporated into a secure operating system residing the peer.

9. The system of claim 1 wherein the validation agent is integrated with an operating system loader to monitor launch of software components on the peer.

10. The system of claim 1 wherein the at least one software component resides on a peer different than the peer hosting the service and the validation agent is operable to communicate with another validation agent residing on the peer which is different than the peer hosting the service.

11. A method of composition trust binding in a peer-to-peer network environment, comprising:
formulating a set of rules at a first peer in the network, the rule set defines software components that may be invoked by a service residing on a second peer remote from the first peer;
communicating the rule set from the first peer to the second peer along with a request to invoke the service; and
verifying that the service executes in accordance with the rule set.

12. The method of claim 11 further comprises encrypting the rule set prior to communicating the rule set to the second peer.

13. The method of claim 11 further comprises invoking the service when the software components defined in the rule set are available on the second peer.

14. The method of claim 11 further comprises invoking the service when a software component invoked by the service is absent from the rule set

15. The method of claim 11 wherein verifying further comprises interacting with a system operating loader to determine software component available on the second peer.

16. The method of claim 11 wherein the rule set defines combinations of two or more allowable software components which may be invoked by the service.

17. The system of claim 1 wherein the rule set further defines software components which are provided by a specified supplier or validated by a specified validator.
